(19) United States
(12) Patent Application Publication
(10) Pub. No.: US 2005/0228673 A1
(43) Pub. Date: Oct. 13, 2005

(54) Techniques for separating and evaluating audio and video source data

(76) Inventors: Ara V. Nefian, San Jose, CA (US); Shyamsundar Rajaram, Urbana, IL (US)

Correspondence Address: SCHWEGMAN, LUNDBERG, WOESSNER & KLUTH, P.A., P.O. BOX 2938, MINNEAPOLIS, MN, 55402-0938, US

(21) Appl. No.: 10/813,642

(22) Filed: Mar. 30, 2004

(51) Int. Cl. G10L 21/00

(52) U.S. Cl. 704/270; 704/246

(57) ABSTRACT

Methods, systems, and apparatus are provided to separate and evaluate audio and video. Audio and video are captured; the audio is evaluated to detect one or more speakers speaking. Visual features are associated with the speakers speaking. The audio and video are separated and corresponding portions of the audio are mapped to the visual features for purposes of isolating audio associated with each speaker and for purposes of filtering out noise associated with the audio.

### TECHNICAL FIELD

Embodiments of the present invention relate generally to audio recognition, and more particularly to techniques for using visual features in combination with audio to improve speech processing.

### BACKGROUND INFORMATION

Speech recognition continues to make advancements within the software arts. In large part, these advances have been possible because of improvements in hardware. For example, processors have become faster and more affordable and memory sizes have become larger and more abundant within the processors. As a result, significant advances have been made in accurately detecting and processing speech within processing and memory devices.

Yet, even with the most powerful processors and abundant memory, speech recognition remains problematic in many respects. For example, when audio is captured from a specific speaker there often is a variety of background noise associated with the speaker's environment. That background noise makes it difficult to detect when a speaker is actually speaking and difficult to detect what portions of the captured audio should be attributed to the speaker as opposed to what portions of the captured audio should be attributed to background noise, which should be ignored.

Another problem occurs when more than one speaker is being monitored by a speech recognition system. This can occur when two or more people are communicating, such as during a video conference. Speech may be properly gleaned from the communications but not capable of being properly associated with a specific one of the speakers. Moreover, in such an environment where multiple speakers exist, it may be that two or more speakers actually speak at the same moment, which creates significant resolution problems for existing and convention speech recognition systems.

Most conventional speech recognition techniques have attempted to address these and other problems by focusing primarily on captured audio and using extensive software analysis to make some determinations and resolutions. However, when speech occurs there are also visual changes that occur with a speaker, namely, the speaker's mouth moves up and down. These visual features can be used for augmenting conventional speech recognition techniques and for generating more robust and accurate speech recognition techniques.

Therefore, there is a need for improved speech recognition techniques that separates and evaluates audio and video in concert with one another.

### BRIEF DESCRIPTION OF THE DRAWINGS

FIG. 1A is a flowchart of a method for audio and video separation and evaluation.

FIG. 1B is a diagram of an example Bayesian network having model parameters produced from the method of FIG. 1A.

FIG. 2 is a flowchart of another method for audio and video separation and evaluation.

FIG. 3 is a flowchart of yet another method for audio and video separation and evaluation.

FIG. 4 is a diagram of an audio and video source separation and analysis system.

FIG. 5 is a diagram of an audio and video source separation and analysis apparatus.

### DESCRIPTION OF THE EMBODIMENTS

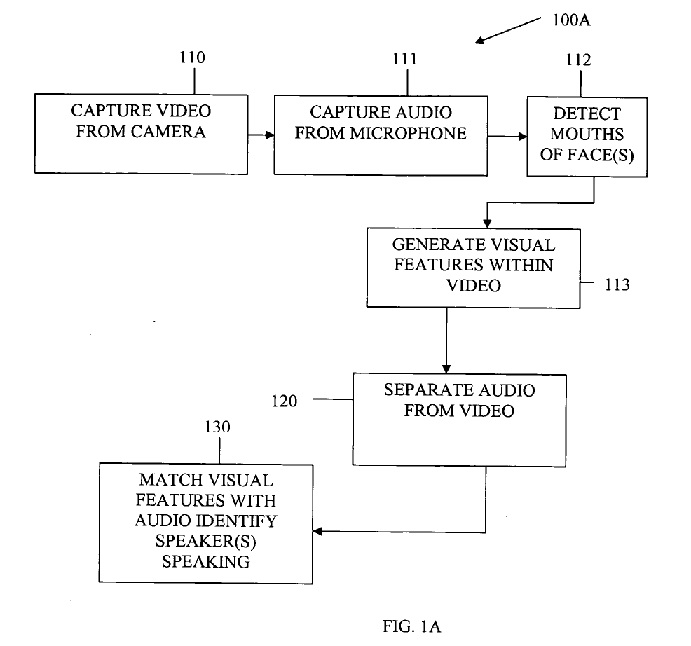

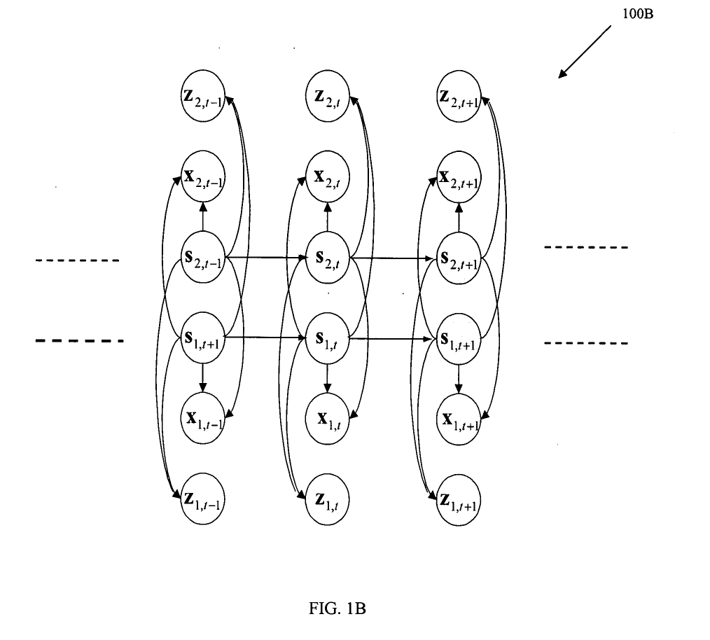

FIG. 1A is a flowchart of one method 100A to separate and evaluate audio and video. The method is implemented in a computer accessible medium. In one embodiment, the processing is one or more software applications which reside and execute on one or more processors. In some embodiment, the software applications are embodied on a removable computer readable medium for distribution and are loaded into a processing device for execution when interfacing with the processing device. In another embodiment, the software applications are processed on a remote processing device over a network, such as a server or remote service.

In still other embodiments, one or more portions of the software instructions are downloaded from a remote device over a network and installed and executed on a local processing device. Access to the software instructions can occur over any hardwired, wireless, or combination of hardwired and wireless networks. Moreover, in one embodiment, some portions of the method processing may be implemented within firmware of a processing device or implemented within an operating system that processes on the processing device.

Initially, an environment is provided in which a camera(s) and a microphone(s) are interfaced to a processing device that includes the method 100A. In some embodiments, the camera and microphone are integrated within the same device. In other embodiments, the camera, microphone, and processing device having the method 100A are all integrated within the processing device. If the camera and/or microphone are not directly integrated into the processing device that executes the method 100A, then the video and audio can be communicated to the processor via any hardwired, wireless, or combination of hardwired and wireless connections or changes. The camera electronically captures video (e.g., images which change over time) and the microphone electronically captures audio.

The purpose of processing the method 100A is to learn parameters associated with a Bayesian network which accurately associates the proper audio (speech) associated with one or more speakers and to also more accurately identify and exclude noise associated with environments of the speakers. To do this, the method samples captured electronic audio and video associated with the speakers during a training session, where the audio is captured electronically by the microphone(s) and the video is captured electronically by the camera(s). The audio-visual data sequence begins at time 0 and continues until time T, where T is any integer number greater than 0. The units of time can be milliseconds, microseconds, seconds, minutes, hours, etc. The length of the training session and the units of time are configurable parameters to the method 100A and are not intended to be limited to any specific embodiment of the invention.

At 110, a camera captures video associated with one or more speakers that are in view of the camera. That video is associated with frames and each frame is associated with a particular unit of time for the training session. Concurrently, as the video is captured, a microphone, at 111 captures audio associated with the speakers. The video and audio at 110 and 111 are captured electronically within an environment accessible to the processing device that executes the method 100A.

As the video frames are captured, they are analyzed or evaluated at 112 for purposes of detecting the faces and mouths of the speakers that are captured within the frames. Detection of the faces and mouths within each frame is done to determine when a frame indicates that mouths of the speakers are moving and when mouths of the speakers are not moving. Initially, detecting the faces assists in reducing the complexity of detecting movements associated with the mouths by limiting a pixel area of each analyzed frame to an area identified as faces of the speakers.

In one embodiment, the face detection is achieved by using a neural network trained to identify a face within a frame. The input to the neural network is a frame having a plurality of pixels and the output is a smaller portion of the original frame having fewer pixels that identifies a face of a speaker. The pixels representing the face are then passed to a pixel vector matching and classifier that identifies a mouth within the face and monitors the changes in the mouth from each face that is subsequently provided for analysis.

One technique for doing this is to calculate the total number of pixels making up a mouth region for which an absolute difference occurring with consecutive frames increases a configurable threshold. That threshold is configurable and if it is exceeded it indicates that a mouth has moved, if it is not exceeded it indicates that a mouth is not moving. The sequences of processed frames can be low pass filtered with a configurable filter size (e.g., 9 or others) with the threshold to generate a binary sequence associated with visual features.

The visual features are generated at 113, and are associated with the frames to indicate which frames have a mouth moving and to indicate which frames have a mouth that is not moving. In this way, each frame is tracked and monitored to determine when a mouth of a speaker is moving and when it is not moving as frames are processed for the captured video.

The above example techniques for identifying when a speaker is speaking and not speaking within video frames are not intended to limit the embodiments of the invention. The examples are presented for purposes of illustration, and any technique used for identifying when a mouth within a frame is moving or not moving relative to a previously processed frame is intended to fall within the embodiments of this invention.

At 120, the mixed audio and video are separated from one another using both audio data from microphones and visual features. The audio is associated with a time line which corresponds directly to the upsampled captured frames of the video. It should be noted that video frames are captured at a different rate than acoustic signals (current devices often allow video capture at 30 fps (frames per second) while audio is captured at 14.4 Kfps (kilo (thousand) frames per second). Moreover, each frame of the video includes visual features that identify when mouths of the speakers that are moving and not moving. Next, audio is selected for a same time slice of corresponding frames which have visual features that indicate mouths of the speakers are moving. That is, at 130, the visual features associated with the frames are matched with the audio during the same time slice associated with both the frames and the audio.

The result is a more accurate representation of audio for speech analysis, since the audio reflects when a speaker was speaking. Moreover, the audio can be attributed to a specific speaker when more than one speaker is being captured by the camera. This permits a voice of one speaker associated with distinct audio features to be discerned from the voice of a different speaker associated with different audio features. Further, potential noise from other frames (frames not indicating mouth movement) can be readily identified along with its band of frequencies and redacted from the band of frequencies associated with speakers when they are speaking. In this way, a more accurate reflection of speech is achieved and filtered from the environments of the speakers and speech associated with different speakers is more accurately discernable, even when two speakers are speaking at the same moment.

The attributes and parameters associated with accurately separating the audio and video and with properly re-matching the audio to selective portions of the audio with specific speakers can be formalized and represented for purposes of modeling this separation and re-matching in a Bayesian network. For example, the audio and visual observations can be represented as Zᵢₜ=[WᵢₜX_{Mt} . . . WᵢₜX_{Mt}]^{T}, t=1−T (where T is an integer number), which are obtained as multiplications between mixed audio observations Xᵢₜ, j=1−M, where M is the number of microphones and the visual features Wᵢₜ, i=1−N, where N is the number of audio-visual sources or speakers. This choice of audio and visual observations improves the acoustic silence detection by allowing a sharp reduction of the audio signal when no visual speech is observed. The audio and visual speech mixing process can be given by the following equations:

$$( 1 ) . P ( {s}_{t} ) = {\prod }_{i} P ( {s}_{it} ) ;$$

$$( 2 ) . P ( {s}_{it} ) \sim N ( 0 , {C}_{s} ) ;$$

$$( 3 ) . P ( {s}_{it} \vert {s}_{it - 1} ) \sim N ( {bs}_{it - 1} , {C}_{ss} ) ;$$

$$( 4 ) . P ( {x}_{it} \vert {s}_{it} ) \sim N ( Σ {a}_{ij} {s}_{jt} , {C}_{x} ) ; and \\ ( 5 ) . P ( {z}_{it} \vert {s}_{it} ) \sim N ( {V}_{i} {s}_{t} , {C}_{z} ) .$$

In the equations (1)-(5), sᵢₜ is the audio sample corresponding to an i^{th} speaker at time t, and Cₛ is the covariance matrix of the audio samples. Equation (1) describes the statistical independencies of the audio sources. Equation (2) describes a Gaussian density function of mean 0 and covariance Cₛ describes the acoustic samples for each source. The parameter b in Equation (3) describes the linear relation between consecutive audio samples corresponding to the same speaker, and Cₛₛ is the covariance matrix of the acoustic samples at consecutive moments of time. Equation (4) shows the Gaussian density function that describes the acoustic mixing process, where A=[aᵢⱼ], I=1−N, j=1−M is the audio mixing matrix and Cₓ is the covariance matrix of the mixed observed audio signal. Vᵢ is an M×N matrix that relates the audio-visual observation Zᵢₜ to the unknown separated source signals, and C_{Z} is the covariance matrix of the audio-visual observations Zᵢₜ. This audio and visual Bayesian mixing model can be seen as a Kalman filter with source independent constraints (identified in Equation (1) above). In learning the model parameters, whitening of the audio observations provides an initial estimate of a matrix A. The model parameters A, V, bᵢ, Cₛ, Cₛₛ, and C_{z}, are learned using a maximum likelihood estimation method. Moreover, the sources are estimated using a constrained Kalman filter and the learned parameters. These parameters can be used to configure a Bayesian network which models the speakers' speech in view of the visual observations and noise. A sample Bayesian network with the model parameters is depicted in diagram 100B of FIG. 1B.

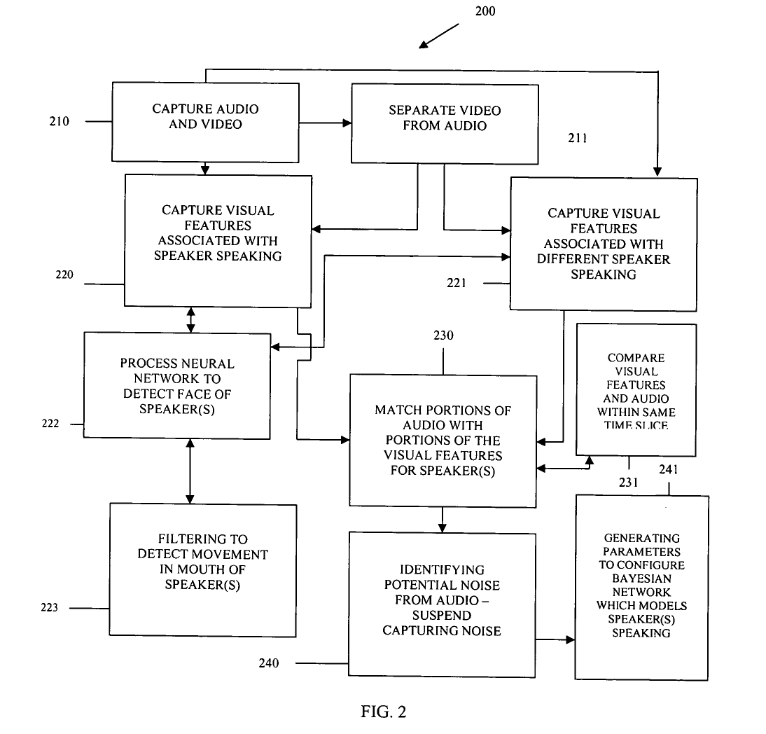

FIG. 2 is a flowchart of another method 200 for audio and video separation and evaluation. The method 200 is implemented in a computer readable and accessible medium. The processing of the method 200 can be wholly or partially implemented on removable computer readable media, within operating systems, within firmware, within memory or storage associated with a processing device that executes the method 200, or within a remote processing device where the method is acting as a remote service. Instructions associated with the method 200 can be accessed over a network and that network can be hardwired, wireless, or a combination of hardwired and wireless.

Initially a camera and microphone or a plurality of cameras and microphones are configured to monitor and capture video and audio associated with one or more speakers. The audio and visual information are electronically captured or recorded at 210. Next, at 211, the video is separated from the audio, but the video and audio maintain metadata that associates a time with each frame of the video and with each piece of recorded audio, such that the video and audio can be re-mixed at a later stage as needed. For example, frame 1 of the video can be associated with time 1, and at time 1 there is an audio snippet 1 associated with the audio. This time dependency is metadata associated with the video and audio and can be used to re-mix or re-integrate the video and audio together in a single multimedia data file.

Next, at 220 and 221, the frames of the video are analyzed for purposes of acquiring and associating visual features with each frame. The visual features identify when a mouth of a speaker is moving or not moving giving a visual clue as to when a speaker is speaking. In some embodiments, the visual features are captured or determined before the video and audio are separated at 211.

In one embodiment, the visual cues are associated with each frame of the video by processing a neural network at 222 for purposes of reducing the pixels which need processing within each frame down to a set of pixels that represent the faces of the speakers. Once a face region is known, the face pixels of a processed frame are passed to a filtering algorithm that detects when mouths of the speakers are moving or not moving at 223. The filtering algorithm keeps track of prior processed frames, such that when a mouth of a speaker is detected to move (open up) a determination can be made that relative to the prior processed frames a speaker is speaking. Metadata associated with each frame of the video includes the visual features which identify when mouths of the speakers are moving or not moving.

Once all video frames are processed, the audio and video can be separated at 211 if it has not already been separated, and subsequently the audio and video can be re-matched or re-mixed with one another at 230. During the matching process, frames having visual features indicating that a mouth of a speaker is moving are remixed with audio during the same time slice at 231. For example, suppose frame 5 of the video has a visual feature indicating that a speaker is speaking and frame 5 was recorded at time 10 and audio snippet at time 10 is acquired and re-mixed with frame 5.

In some embodiments, the matching process can be more robust such that a band of frequencies associated with audio in frames that have no visual features indicating that a speaker is speaking can be noted as potential noise, at 240, and used in frames that indicate a speaker is speaking for purposes of eliminating that same noise from audio that is being matched to the frames where the speaker is speaking.

For example, suppose a first frequency band is detected within the audio at frames 1-9 where the speaker is not speaking and that in frame 10 the speaker is speaking. The first frequency band also appears with the corresponding audio matched to frame 10. Frame 10 is also matched with audio having a second frequency band. Therefore, since it was determined that the first frequency band is noise, this first frequency band can be filtered out of the audio matched to frame 10. The result is a clearly more accurate audio snippet which is matched to frame 10 and this will improve speech recognition techniques that are performed against that audio snippet.

In a similar manner, the matching can be used to discern between two different speakers speaking within a same frame. For example, consider that at frame 3, a first speaker speaks and at frame 5 a second speaker speaks. Next, consider that at frame 10 both the first and second speaker both are speaking concurrently. The audio snippet associated with frame 3 has a first set of visual features and the audio snippet at frame 5 has a second set of visual features. Thus, at frame 10 the audio snippet can be filtered into two separate segments with each separate segment being associated with a different speaker. The technique discussed above for noise elimination may also be integrated and augmented with the technique used to discern between to separate speakers, which are concurrently speaking, in order to further enhance the clarity of the captured audio. This permits speech recognition systems to have more reliable audio to analyze.

In some embodiments, as was discussed above with respect to FIG. 1A, the matching process can be formalized to generate parameters which can be used at 241 to configure a Bayesian network. The Bayesian network configured with the parameters can be used to subsequently interact with the speakers and make dynamic determinations to eliminate noise and discern between different speakers and discern between different speakers which are both speaking at the same moments. That Bayesian network may then filter out or produce a zero output for some audio when it recognizes at any given processing moment that the audio is potential noise.

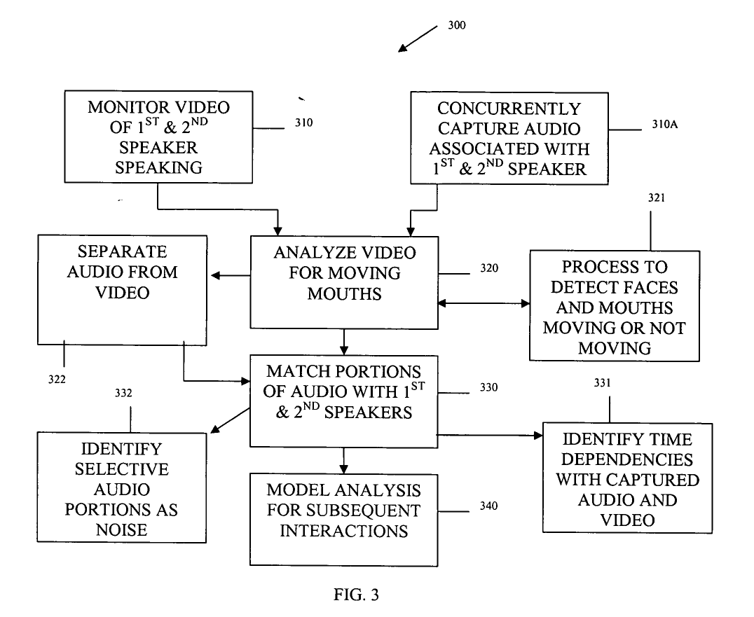

FIG. 3 is a flowchart of yet another method 300 for separating and evaluating audio and video. The method is implemented in a computer readable and accessible medium as software instructions, firmware instructions, or a combination of software and firmware instructions. The instructions can be installed on a processing device remotely over any network connection, pre-installed within an operating system, or installed from one or more removable computer readable media. The processing device that executes the instructions of the method 300 also interfaces with separate camera or microphone devices, a composite microphone and camera device, or a camera and microphone device that is integrated with the processing device.

At 310, video is monitored associated with a first speaker and a second speaker which are speaking. Concurrently with the monitored video, at 310A, audio is captured associated with the voice of the first and second speakers and associated with any background noise associated with the environments of the speakers. The video captures images of the speakers and part of their surroundings and the audio captures speech associated with the speakers and their environments.

At 320, the video is decomposed into frames; each frame is associated with a specific time during which it was recorded. Furthermore, each frame is analyzed to detect movement or non-movement in the mouths of the speakers. In some embodiments, at 321, this is achieved by decomposing the frames into smaller pieces and then associating visual features with each of the frames. The visual features indicate which speaker is speaking and which speaker is not speaking. In one scenario, this can be done by using a trained neural network to first identify the faces of the speakers within each processed frame and then passing the faces to a vector classifying or matching algorithm that looks for movements of mouths associated with the faces relative to previously processed frames.

At 322, after each frame is analyzed for purposes of acquiring visual features, the audio and video are separated. Each frame of video or snippet of audio includes a time stamp associated with when it was initially captured or recorded. This time stamp permits the audio to be re-mixed with the proper frames when desired and permits the audio to be more accurately matched to a specific one of the speakers and permits noise to be reduced or eliminated.

At 330, portions of the audio are matched with the first speaker and portions of the audio are matched with the second speaker. This can be done in a variety of manners based on each processed frame and its visual features. Matching occurs based on time dependencies of the separated audio and video at 331. For example, frames matched to audio with the same time stamp where those frames have visual features indicating that neither speaker is speaking can be used to identify bands of frequencies associated with noise occurring within the environments of the speakers, as depicted at 332. An identified noise frequency band can be used in frames and corresponding audio snippets to make the detected speech more clear or crisp. Moreover, frames matched to audio where only one speaker is speaking can be used to discern when both speakers are speaking in different frames by using unique audio features.

In some embodiments, at 340, the analysis and/or matching processes of 320 and 330 can be modeled for subsequent interactions occurring with the speakers. That is, a Bayesian network can be configured with parameters that define the analysis and matching, such that the Bayesian model can determine and improve speech separation and recognition when it encounters a session with the first and second speakers a subsequent time.

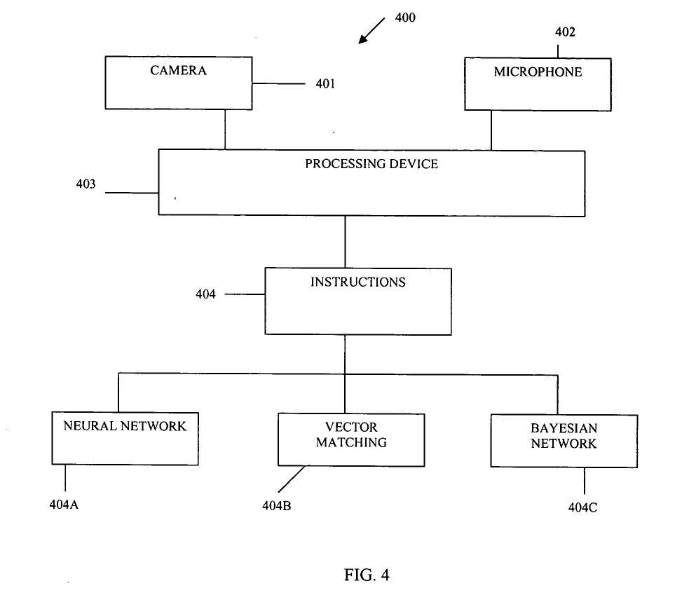

FIG. 4 is a diagram of an audio and video source separation and analysis system 400. The audio and video source separation and analysis system 400 is implemented in a computer accessible medium and implements the techniques discussed above with respect to FIGS. 1A-3 and methods 100A, 200, and 300, respectively. That is the audio and video source separation and analysis system 400 when operational improves the recognition of speech by incorporating techniques to evaluate video associated with speakers in concert with audio emanating from the speakers during the video.

The audio and video source separation and analysis system 400 includes a camera 401, a microphone 402, and a processing device 403. In some embodiments, the three devices 401-403 are integrated into a single composite device. In other embodiments, the three devices 401-403 are interfaced and communicate with one another through local or networked connections. The communication can occur via hardwired connections, wireless connections, or combinations of hardwired and wireless connections. Moreover, in some embodiments, the camera 401 and the microphone 402 are integrated into a single composite device (e.g., video camcorder, and the like) and interfaced to the processing device 403.

The processing device 403 includes instructions 404, these instructions 404 implement the techniques presented above in methods 100A, 200, and 300 of FIGS. 1A-3, respectively. The instructions receive video from the camera 401 and audio from the microphone 402 via the processor 403 and its associated memory or communication instructions. The video depicts frames of one or more speakers that are either speaking or not speaking, and the audio depicts audio associated with background noise and speech associated with the speakers.

The instructions 404 analyze each frame of the audio for purposes of associating visual features with each frame. Visual features identify when a specific speaker or both speakers are speaking and when they are not speaking. In some embodiments, the instructions 404 achieve this in cooperation with other applications or sets of instructions. For example, each frame can have the faces of the speakers identified with a trained neural network application 404A. The faces within the frames can be passed to a vector matching application 404B that evaluates faces in frames relative to faces of previously processed frames to detect if mouths of the faces are moving or not moving.

The instructions 404, after visual features are associated with each frame of the video, separates the audio and the video frames. Each audio snippet and video frame includes a time stamp. The time stamp may be assigned by the camera 401, the microphone 402, or the processor 403. Alternatively, when the instructions 404 separate the audio and video, the instructions 404 assign time stamps at that point in time. The time stamp provides time dependencies which can be used to re-mix and re-match the separated audio and video.

Next, the instructions 404 evaluate the frames and the audio snippets independently. Thus, frames with visual features indicating no speaker is speaking can be used for identifying matching audio snippets and their corresponding band of frequencies for purposes of identifying potential noise. The potential noise can be filtered from frames with visual features indicating that a speaker is speaking to improve the clarity of the audio snippet; this clarity will improve speech recognition systems that evaluate the audio snippet. The instructions 404 can also be used to evaluate and discern unique audio features associated with each individual speaker. Again, these unique audio features can be used to separate a single audio snippet into two audio snippets each having unique audio features associated with a unique speaker. Thus, the instructions 404 can detect individual speakers when multiple speakers are concurrently speaking.

In some embodiments, the processing that the instructions 404 learn and perform from initially interacting with one or more speakers via the camera 401 and the microphone 402 can be formalized into parameter data that can be configured within a Bayesian network application 404C. This permits the Bayesian network application 404C to interact with the camera 401, the microphone 402, and the processor 403 independent of the instructions 404 on subsequent speaking sessions with the speakers. If the speakers are in new environments, the instructions 404 can be used again by the Bayesian network application 404C to improve its performance.

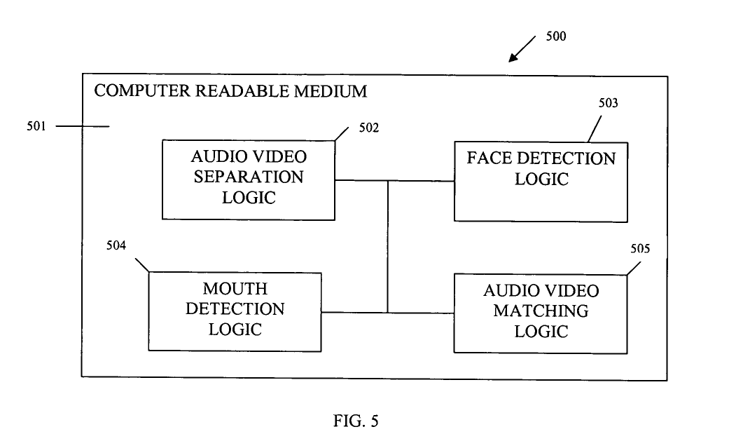

FIG. 5 is a diagram of an audio and video source separation and analysis apparatus 500. The audio and video source separation and analysis apparatus 500 resides in a computer readable medium 501 and is implemented as software, firmware, or a combination of software and firmware. The audio and video source separation and analysis apparatus 500 when loaded into one or more processing devices improves the recognition of speech associated with one or more speakers by incorporating audio that is concurrently monitored when the speech takes place. The audio and video source separation and analysis apparatus 500 can reside entirely on one or more computer removable media or remote storage locations and subsequently transferred to a processing device for execution.

The audio and video source separation and analysis apparatus 500 includes audio and video source separation logic 502, face detection logic 503, mouth detection logic 504, and audio and video matching logic 505. The face detection logic 503 detects the location of faces within frames of video. In one embodiment, the face detection logic 503 is a trained neural network designed to take a frame of pixels and identify a subset of those pixels as a face or a plurality of faces.

The mouth detection logic 504 takes pixels associated with faces and identifies pixels associated with a mouth of the face. The mouth detection logic 504 also evaluates multiple frames of faces relative to one another for purposes of determining when a mouth of a face moves or does not move. The results of the mouth detection logic 504 are associated with each frame of the video as a visual feature, which is consumed by the audio video matching logic.

Once the mouth detection logic 504 has associated visual features with each frame of a video, the audio and video separation logic 503 separates the video from the audio. In some embodiments, the audio and video separation logic 503 separates the video from the audio before the mouth detection logic 504 processes each frame. Each frame of video and each snippet of audio includes time stamps. Those time stamps can be assigned by the audio and video separation logic 502 at the time of separation or can be assigned by another process, such as a camera that captures the video and a microphone that captures the audio. Alternatively, a processor that captures the video and audio can use instructions to time stamp the video and audio.

The audio and video matching logic 505 receives separate time stamped streams of video frames and audio, the video frames have the associated visual features assigned by the mouth detection logic 504. Each frame and snippet is then evaluated for purposes of identifying noise, identifying speech associated with specific and unique speakers. The parameters associated with this matching and selective re-mixing can be used to configure a Bayesian network which models the speakers speaking.

Some components of the audio and video source separation and analysis apparatus 500 can be incorporated into other components and some additional components not included in FIG. 5 can be added. Thus, FIG. 5 is presented for purposes of illustration only and is not intended to limit embodiments of the invention.

The above description is illustrative, and not restrictive. Many other embodiments will be apparent to those of skill in the art upon reviewing the above description. The scope of embodiments of the invention should therefore be determined with reference to the appended claims, along with the full scope of equivalents to which such claims are entitled.

The Abstract is provided to comply with 37 C.F.R. §1.72(b) requiring an Abstract that will allow the reader to quickly ascertain the nature and gist of the technical disclosure. It is submitted with the understanding that it will not be used to interpret or limit the scope or meaning of the claims.

In the foregoing description of the embodiments, various features are grouped together in a single embodiment for the purpose of streamlining the disclosure. This method of disclosure is not to be interpreted as reflecting an intention that the claimed embodiments of the invention require more features than are expressly recited in each claim. Rather, as the following claims reflect, inventive subject matter lies in less than all features of a single disclosed embodiment. Thus the following claims are hereby incorporated into the Description of the Embodiments, with each claim standing on its own as a separate exemplary embodiment.

1. A method, comprising:
electronically capturing visual features associated with a speaker speaking;
electronically capturing audio;
matching selective portions of the audio with the visual features; and
identifying the remaining portions of the audio as potential noise not associated with the speaker speaking.

2. The method of claim 1 further comprising:
electronically capturing additional visual features associated with a different speaker speaking; and
matching some of the remaining portions of the audio from the potential noise with the additional speaker speaking.

3. The method of claim 1 further comprising generating parameters associated with the matching and the identifying and providing the parameters to a Bayesian Network which models the speaker speaking.

4. The method of claim 1 wherein electronically capturing the visual features further includes processing a neural network against electronic video associated with the speaker speaking, wherein the neural network is trained to detect and monitor a face of the speaker.

5. The method of claim 4 further comprising filtering the detected face of the speaker to detect movement or lack of movement in a mouth of the speaker.

6. The method of claim 1 wherein matching further includes comparing portions of the captured visual features against portions of the captured audio during a same time slice.

7. The method of claim 1 further comprising suspending the capturing of audio during periods where select ones of the captured visual features indicate that the speaker is not speaking.

8. A method, comprising:
monitoring an electronic video of a first speaker and a second speaker;
concurrently capturing audio associated with the first and second speaker speaking;
analyzing the video to detect when the first and second speakers are moving their respective mouths; and
matching portions of the captured audio to the first speaker and other portions to the second speaker based on the analysis.

9. The method of claim 8 further comprising modeling the analysis for subsequent interactions with the first and second speakers.

10. The method of claim 8 wherein analyzing further includes processing a neural network for detecting faces of the first and second speakers and processing vector classifying algorithms to detect when the first and second speakers' respective mouths are moving or not moving.

11. The method of claim 8 further comprising separating the electronic video from the concurrently captured audio in preparation for analyzing.

12. The method of claim 8 further comprising suspending the capturing of audio when the analysis does not detect the mouths moving for the first and second speakers.

13. The method of claim 8 further comprising identifying selective portions of the captured audio as noise if the selective portions have not been matched to the first speaker or the second speaker.

14. The method of claim 8 wherein matching further includes identifying time dependencies associated with when selective portions of the electronic video were monitored and when selective portions of the audio were captured.

15. A system, comprising:
a camera;
a microphone; and
a processing device, wherein the camera captures video of a speaker and communicates the video to the processing device, the microphone captures audio associated with the speaker and an environment of the speaker and communicates the audio to the processing device, the processing device includes instructions that identifies visual features of the video where the speaker is speaking and uses time dependencies to match portions of the audio to those visual features.

16. The system of claim 15 wherein the captured video also includes images of a second speaker and the audio includes sounds associated with the second speaker, and wherein the instructions matches some portions of the audio to the second speaker when some of the visual features indicate the second speaker is speaking.

17. The system of claim 15 wherein the instructions interact with a neural network to detect a face of the speaker from the captured video.

18. The system of claim 17 wherein the instructions interact with a pixel vector algorithm to detect when a mouth associated with the face moves or does not move within the captured video.

19. The system of claim 18 wherein the instructions generate parameter data that configures a Bayesian network which models subsequent interactions with the speaker to determine when the speaker is speaking and to determine appropriate audio to associate with the speaker speaking in the subsequent interactions.

20. A machine accessible medium having associated instructions, which when accessed, results in a machine performing:
separating audio and video associated with a speaker speaking;
identifying visual features from the video that indicate a mouth of the speaker is moving or not moving; and
associating portions of the audio with selective ones of the visual features that indicate the mouth is moving.

21. The medium of claim 20 further including instructions for associating other portions of the audio with different ones of the visual features that indicate the mouth is not moving.

22. The medium of claim 20 further including instructions for:
identifying second visual features from the video that indicate a different mouth of another speaker is moving or not moving; and
associating different portions of the audio with selective ones of the second visual features that indicate the different mouth is moving.

23. The medium of claim 20 wherein the instructions for identifying further include instructions for:
processing a neural network to detect a face of the speaker; and
processing a vector matching algorithm to detect movements of the mouth of the speaker within the detected face.

24. The medium of claim 20 wherein the instructions for associating further include instructions for matching same time slices associated with a time that the portions of the audio were captured and the same time during which the selective ones of the visual features were captured within the video.

25. An apparatus, residing in a computer-accessible medium, comprising:
face detection logic;
mouth detection logic; and
audio-video matching logic, wherein the face detection logic detects a face of a speaker within a video, the mouth detection logic detects and monitors movement and non-movement of a mouth included within the face of the video, and the audio-video matching logic matches portions of captured audio with any movements identified by the mouth detection logic.

26. The apparatus of claim 25 wherein the apparatus is used to configure a Bayesian network which models the speaker speaking.

27. The apparatus of claim 25 wherein the face detection logic comprises a neural network.

28. The apparatus of claim 25 wherein the apparatus resides on a processing device and the processing device is interfaced to a camera and a microphone.
